(19) United States
(12) Patent Application Publication
(10) Pub. No.: US 2005/0157654 A1
(43) Pub. Date: Jul. 21, 2005

(54) Apparatus and method for automated discovery and monitoring of relationships between network elements

(76) Inventors: Craig Anthony Farrell, San Diego, CA (US); Thanes Duke Tantiprasut, San Diego, CA (US)

Correspondence Address: BROWN RAYSMAN MILLSTEIN FELDER & STEINER LLP, 900 THIRD AVENUE, NEW YORK, NY, 10022, US

(21) Appl. No.: 10/901,680

(22) Filed: Jul. 29, 2004

Related U.S. Application Data
(63) Continuation of application No. 09/689,514, filed on Oct. 12, 2000, now abandoned.

(51) Int. Cl. H04L 1/00

(52) U.S. Cl. 370/241; 709/224

(57) ABSTRACT

A network discovery and monitoring apparatus and method of using the same. An apparatus includes an agent configured for being hosted on one of a plurality of interconnected network elements that form at least a portion of a communication network. A method includes the agent gathering application data representing a network-based application that is accessible from the network element hosting the agent. The agent monitors application traffic between each discovered application and any network element having a relationship to the application. A result of the monitoring is a relational topology, at the application layer, of the network elements in the network.

### BACKGROUND OF THE INVENTION

1. Field of the Invention

This invention relates generally to communication networks. In particular, this invention relates to the discovery and monitoring of relationships among network elements within a network.

2. Description of the Related Art

A communication network is made up of interconnected network elements. A network element is any device or computer program that functions as a communication node in the network. Servers are a specific type of network element. The term “server” refers to a computer program that provides services to other computer programs with the same computing platform, or to other computer platforms. A server is also known to refer to a computer platform on which a server program is run. In a client/server networking model, a server is a program that receives and fulfills requests from client programs in the same or other computers. In a specific example, a Web server is the computer program, executed by a computer, that serves requested hypertext markup language (HTML) pages or files.

A client is another specific type of network element. The term “client” refers to a computer program that requests data from a server. For example, a user of a World Wide Web (herein, “Web”) browser application makes client requests for hypertext markup language (HTML) pages from Web servers. The browser application is itself a client in a relationship with the Web server that returns the requested HTML file. Thus, the computer program that handles the request and returns the HTML file is the server. Other network elements include the intermediate communication nodes used on a communication route between a server and a client, such as repeaters or routers.

Knowledge of the availability and performance of the network elements is important to the overall operation of the network. Data about network performance is normally gathered by a centralized network management system (NMS). The NMS conventionally operates according to a universal network management protocol for efficient and compatible management across all elements of the network. One such protocol is known as simple network management protocol (SNMP). SNMP governs network management and the monitoring of network devices and their functions.

Network monitoring normally involves the querying of network elements from a centralized vantage point to obtain data about the network elements. The data obtained is usually a listing of network elements, and possibly a listing of application port numbers on which a given network element has a listener process. The data generally provides an atomistic view of network elements, by identifying clients, servers, and other network elements of the network, without defining any further relationship between any given network element and the rest of the network.

Two main methods presently exist for discovering network clients, servers, other network elements, and their applications. One method is known as “ping flooding.” In ping flooding, or its variants, a packet source floods the network with packets. The packet source may be a central server, the NMS, or a distributed agent within the network. The packet source then monitors the network to see which network elements respond to a packet. Accordingly, any network elements that respond are “discovered” by the ping flooding process.

A second method is known as “port sweeping,” a finer-grained network discovery and monitoring method that extends on ping flooding. In port sweeping, once a network element has been discovered, an attempt is made, usually by the packet source, to connect to the network element using a number of connection ports on the network element platform. As different applications “listen” to the network on different ports, port sweeping will reveal what applications on the network element, also known as “services,” are currently available or “listening.”

An additional method of network discovery includes a monitoring process, and is used for discovering which applications are used or available on a host network element. Such a method includes having the host provide information on its hosted and available applications. An example of this method is a host resources management information base (MIB), a description of a set of network objects that can be managed using SNMP, which is described in MIB RFC 1514, for example.

Port sweeping, ping flooding, and other current network discovery and monitoring methods are limited to providing data only about the existence of network elements, and do not extend to defining relationships between the network elements. Furthermore, existing network management methods do not extend to discovering and monitoring application-layer relationships.

The problems and limitations of prior art monitoring methods are evident in a specific example in which such methods are used. A traffic generator is a network apparatus used to generate, or simulate, traffic conditions for purposes of data collection and benchmarking. Current traffic generators work by “recording” a transaction which will be repeated many times from various vantage points. The transaction could be a simulated application process that is provided by a server to a client. Once recorded, the transaction is then provided to various remote agents within the network for execution, and metrics, such as response time, are calculated for simulated users at those remote locations. The traffic generators in this example simply replay the traffic from multiple locations to the same application server. The problem is that different remote locations may use different servers to provide the same applications.

### SUMMARY OF THE INVENTION

This invention relates to a distributed agent configured for discovering elements of a network and monitoring relationships between the network elements. Preferably, the network elements include, without limitation, clients, servers, intermediate communication nodes and applications programs. According to the invention, an agent is hosted on at least one network element. The agent discovers what applications are running on the host network element, and which servers are used for serving each of the discovered applications. The discovery is preferably, although not necessarily from the point of view of a client of the discovered applications and application servers. The invention also discovers relationships among clients or other network elements in the network. The agent may also reside on the server to discover which clients use it for which applications.

Another embodiment of the invention includes the steps of hosting an agent on at least one of a plurality of interconnected network elements, where the agent is configured to gather application data representing a network-based application for use by the host network element. Using the agent, application traffic is monitored between the application and at least one other network element.

Another embodiment of the invention includes the steps of hosting an agent on at least one of a plurality of interconnected network elements, and gathering application data with the agent. The application data represents a network-based application for use by the host network element. A further step is monitoring, using the agent, application traffic between the application and any other network element having a relationship with the application.

In still yet another embodiment of the invention, a method includes the steps of hosting an agent on at least one of a plurality of interconnected network elements, for autonomously gathering application data with said hosted agent, and using said agent, monitoring application traffic between the application and any other network element having a relationship to the application.

In yet another embodiment of the invention, an apparatus for monitoring a network includes an agent being configured to gather application data representing a network-based application, and further being configured to monitor application traffic between the application and any network element in the network having a relationship to the application. The apparatus further includes an agent hosting means for hosting the agent on one of a plurality of interconnected network elements.

### BRIEF DESCRIPTION OF THE DRAWING

FIG. 1 is a diagram of a network topology in which the present invention is used.

FIG. 2 is a flow chart illustrating a method of monitoring a network according to an embodiment of the present invention.

FIG. 3 is a functional diagram of an agent apparatus and monitoring system according to the present invention.

### DETAILED DESCRIPTION OF THE PREFERRED EMBODIMENTS

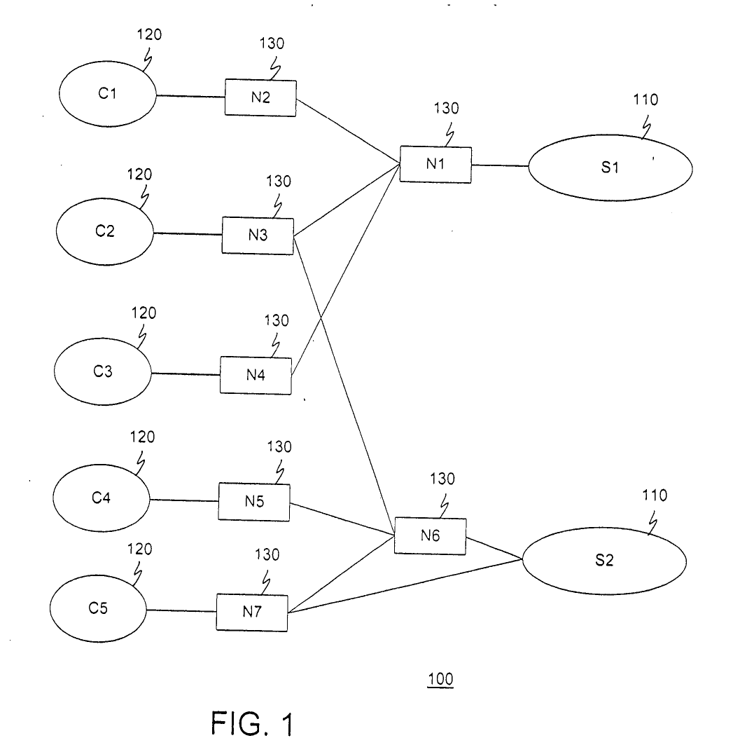

FIG. 1 shows a simplified network topology as an example of a communication network for which the present invention is suited. A network 100 includes a plurality of interconnected network elements. The network elements include servers 110 connected with clients 120 via one or more intermediate network elements 130. It should be understood that the network illustrated in FIG. 1 is described herein for purposes of illustrating exemplary embodiments of the present invention. Those skilled in the art would recognize that the present invention may be used in more complex networks, or that servers and clients may be directly connected, i.e. sharing the same computer device, or that the number and extent of intermediate network elements may vary between communicating network elements. Those skilled in the art will also recognize that computers may also be both clients and servers either separately or concurrently. For example, a web server machine serving HTML pages may also run a web browser and hence be a client as well.

In accordance with an embodiment of the present invention, each clients 120 and the servers 110 represents one or more applications employed in a certain manner by the respective network elements. The servers 110 receive and respond to requests from the clients 120. One example of an application in the client/server model is electronic mail (“e-mail”), where a client 120 includes an e-mail program that sends and receives e-mail files via an e-mail server 110. Another example application is Internet service. A client 120 runs an Web browsing application program for searching the Web, and requests from the client 120 are received and fulfilled by a Web server 110 running a Web-serving application.

In an embodiment of the invention, a distributed agent is a program running on at least one of the network elements, such as one of the servers 110 or clients 120, to monitor application traffic in order to discover a relationship between clients, servers, applications, and the intermediate network elements. By employing a plurality of distributed agents in the network, a complete application-level topology and relationship structure may be ascertained. According to the embodiment, a relationship may be defined in many ways, such as which clients use which servers, for which applications, and what intermediate network elements are used to establish the application-level connection between clients and servers.

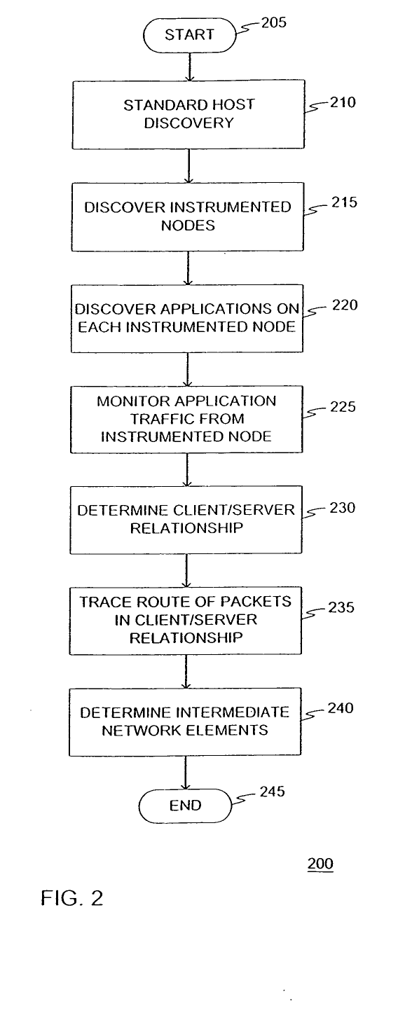

Referring now to FIG. 2, a method 200 of monitoring a network begins at start block 205, in which network elements of a network are configured with distributed network-monitoring agents. In a specific preferred embodiment of the invention, all of the client network elements include an agent. However, in alternative embodiments, any single or combination of network elements, including servers, may contain an agent. The agent may be pre-installed at the network element, or downloaded according to any of the known file transfer protocols currently in use with networked communications.

At function block 210, a standard host discovery process is executed. The discovery process may be any known process, such as ping flooding and/or port sweeping described above. Host discovery is executed at function block 210 to discover which network elements are running the application-monitoring agent. Any network element hosting an agent or running an agent program is referred to herein as a host network element. In other words a network element that is discovered is referred to as an “instrumented” node of the network at block 215. All instrumented nodes are thus self-identified and discoverable by a central NMS.

At function block 220, each host network element's agent discovers which applications are installed on their host. Function block 220 is preferably executed in accordance with the Host Resources RFC 1514 or equivalent management information base (MIB) functionality, according to an exemplary embodiment of the invention. Such functionality requires the agent to support certain selected MIB specifications.

After the applications installed on the host are obtained, the agent begins monitoring application traffic for each application. From the vantage point of the host network element, gathering application traffic data by monitoring application traffic enables discovery by the agent of a client/server relationship of each application, at function block 230. Thus, illustrated with reference to block 230, the agent determines which clients are communicating with which servers for running certain networking applications, and the determination is made at the application level.

When the servers of each application are known, i.e. the client/server relationship is established for each application. At function block 235 the agent executes a route tracing process to trace the route of the application traffic between the server and the client. With reference to FIG. 1, one or more intermediate network elements may be deployed between each server and its respective client or clients. Further, each client may access more than one server for running more than one application, or for running the same application. The intermediate network elements define successive nodes in a route between a server 110 and a client 120 for each discovered relationship as described above. Having thus determined the route and the intermediate network elements used, the agent obtains a complete topological view of the network, from the application-level perspective.

Auto discovery of applications, servers, and intermediate network elements by client-hosted distributed agents, in accordance with the present invention, provides a unique “client view” of the network and networked applications. The client view, in turn, provides valuable information about the interrelationships of network elements that is otherwise very difficult and time consuming to obtain.

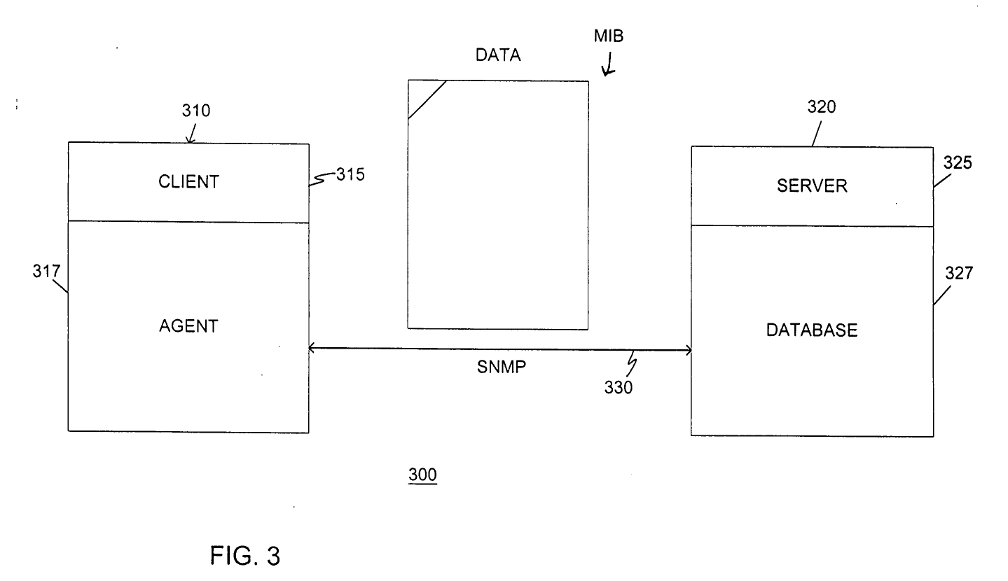

FIG. 3 shows a system 300 for monitoring a network including an agent apparatus 317. In a preferred exemplary embodiment, the agent 317 is hosted on a client 315 makes up a portion of a first network element platform 310. A second network element platform 320 includes a server 325, and has a database 327. The database 327 stores a network management system, configured to monitor the status of the network to which the network element platforms 310 and 320 belong, in accordance with standard practice of network management operation.

The agent 317 is configured to communicate with the database 327 via a connection that supports SNMP. In accordance with the present invention, the agent 317 monitors network operations from the point of view of the client 315, including any applications running on the client, and interrelationships with the rest of the network. Data monitored and collected by the agent 317 is provided in an electronic document formatted according to a MIB specification, which is then reported to the database via the SNMP connection. The network management system uses the data provided by the agent for more detailed and useful monitoring of the network, according to the teachings of the present invention.

Referring back to FIGS. 1 and 2, example uses of the agent apparatus of the present invention will now be described. If an agent is deployed on all clients 120 (C1-C5), or on all the servers 110 (S1-S2), execution of the method 200 might yield, for example, the following information:
C1 uses S1 for e-mail;
C1 uses S1 for web serving;
C2 uses S2 for e-mail;
C2 uses S2 for web serving;
C3 uses S1 for e-mail;
C3 uses S1 for web serving;
C4 uses S2 for e-mail;
C4 uses S2 for web serving;
C5 uses S1 for e-mail;
C5 uses S2 for web serving;

Event Correlation

The client, server, and application information obtained by execution of a method according to the present invention is provided to an event correlator. An
C4 uses S2 for e-mail;
C4 uses S2 for web serving;
C5 uses S1 for e-mail;
C5 uses S2 for web serving;

Event Correlation

The client, server, and application information obtained by execution of a method according to the present invention is provided to an event correlator. An event correlator is an apparatus, such as a processor or a computer program, which correlates operations with corresponding network elements. The event correlator would generate statistics such as, for example, if S1's e-mail serving application fails, application traffic “events” would still be obtained from C1, C2, C3 and C5, but not from C4. C5 would report failure of its e-mail server but not failure of its web server. Thus, the event correlator, using data accumulated according to the invention, extends conventional network diagnostic systems that may determine “the server is up/down” to now enable a determination such as “the web serving application still works on S1 but e-mail is down” for example. The monitoring data provided by the present is therefore useful for fine-grained application layer diagnostics.

Root Cause Analysis

Network analysis tools can utilize data provided by the agent apparatus according to the present invention to diagnose a root cause of an event, such as a failure or interrupt. The present invention extends conventional failure diagnostics to incorporate information about the application layer of a network for more effective isolation of failure points in the network.

Capacity Planning and Risk Analysis

In addition to providing a physical and logical topological view of a network, the present invention also provides an application-specific view of the network. For example, for a server that runs a particular application which it serves to a number of clients, the present invention can provide a view of the network from that application's view on the server. In risk analysis, knowing which application or network services will be affected by a failure of a specific network element can be provided by the present invention and assessed to minimize risk. For capacity planning and load balancing, knowing which servers and clients rely on each other for services and applications allows for more efficient planning of resources, such as which resources to upgrade, etc.

Software Licensing

The present invention provides data about which servers of a particular application and/or service provides necessary information for auditing of software licenses in a distributed networked environment. For example, if a product is installed on a server is a C++ compiler, the present invention assists tracking those clients that do not host the compiler, but nevertheless use it.

Traffic Generator

Traffic generators repeatedly transmit pre-programmed data over a network to remote agents in order to measure response time, etc. The present invention can be used to supplement the functions provided by traffic generators by providing information about which server is accessed and used from a specific client location. Simulated communication playback could be reconfigured and/or automatically modified to continually retransmit the pre-programmed data using the appropriate application server for a particular client.

These and other uses, embodiments, combinations and modifications of the present invention will occur readily to those of ordinary skill in the art in view of these teachings. Therefore, this invention is to be limited only by the following claims, which include all such embodiments and modifications when viewed in conjunction with the above specification and accompanying drawings.

1. A method of monitoring a network, comprising:
hosting an agent on at least one of a plurality of interconnected network elements, wherein the agent is configured to gather application data representing a network-based application for use by the host network element; and
using the agent, monitoring application traffic between the application and at least one other network element.

2. The method according to claim 1, further comprising tracing a route of the application traffic with the agent.

3. The method according to claim 2, wherein the tracing the route includes identifying a server of the application.

4. The method according to claim 3, wherein the tracing the route includes identifying a client of the server.

5. The method according to claim 4, wherein the tracing the route includes identifying any intermediate network elements along the route between the server and the client.

6. The method according to claim 4, wherein the client is the host network element.

7. The method according to claim 1, wherein the agent is further configured to identify a relationship between the application and the other network element based on the application traffic.

8. The method according to claim 7, wherein the relationship is a client/server relationship.

9. The method according to claim 7, wherein the relationship is a peer-to-peer relationship.

10. A method of monitoring a network, comprising:
hosting an agent on at least one of a plurality of interconnected network elements;
gathering, with said agent, application data representing a network-based application for use by the host network element; and
using said agent, monitoring application traffic between the application and any other network element having a relationship with the application.

11. The method according to claim 10, wherein the monitoring further comprises tracing a route of said application traffic.

12. The method according to claim 10, wherein the application data includes data representing a server of the application.

13. The method according to claim 10, further comprising reporting the application data and application traffic data to a network management system.

14. The method according to claim 13, wherein the network management system is hosted on a different one of the network elements.

15. The method according to claim 12, wherein the monitoring further comprises identifying any intermediate network elements between the server and a client traversed by said application traffic.

16. The method according to claim 15, wherein the monitoring further comprises tracing a route between the server and the client.

17. The method according to claim 16, wherein the route forms an topology of network elements for the application.

18. The method according to claim 10, further comprising repeating the gathering application data and the monitoring application traffic for each network-based application used by the host network element.

19. The method according to claim 18, wherein the monitoring further comprising tracing a route between a server and a client of each application.

20. (canceled)

21. A method of monitoring a network, comprising:
hosting an agent on at least one of a plurality of interconnected network elements, for autonomously gathering application data with said hosted agent, wherein the application data represents a network-based application for use by the host network element; and
using said agent, monitoring application traffic between the application and any other network element having a relationship to the application.

22-26. (canceled)
